(19) United States
(12) Patent Application Publication
(10) Pub. No.: US 2023/0018563 A1
(43) Pub. Date: Jan. 19, 2023

(54) HIGH PRECISION TRACKPAD AND METHODS OF MANUFACTURE

(71) Applicant: Steven Christopher Welch, Yanceyville, NC (US)

(72) Inventor: Steven Christopher Welch, Yanceyville, NC (US)

(21) Appl. No.: 17/378,731

(22) Filed: Jul. 18, 2021

(51) Int. Cl. G06F 3/039; C23C 28/04; G06F 3/0354

(52) U.S. Cl. CPC G06F 3/0395; C23C 28/042; G06F 3/03543

(57) ABSTRACT

The present invention relates to a mouse pad comprising a flat metal alloy sheet having a surface that has been treated with a ceramic and polymer coating to provide the surface with a desired friction co-efficient. A method of manufacture of the mousepad is also provided.

### TECHNICAL FIELD

The present invention relates generally to trackpads for facilitating electronic mouse movement. More specifically, the present invention relates to a high precision mouse pad having an optimal friction co-efficient and methods for the manufacture thereof.

### BACKGROUND

With the increasing reliance on technology in the modern world and an ever increasing need for computer accessories to keep up with the improvement progress of software and hardware, as well as the development industries such as E-sports which provide even greater incentive for high precision computer control, there is clearly a need for high end track pads which not only provide optimal friction coefficients for movement of electronic mice across their surface, but also provide a surface which the optical detection sensors of the electronic mouse can easily detect movement across.

It is within this context that the present invention is provided.

### SUMMARY

The present invention provides a mouse pad comprised of a hard metal alloy sheet bonded with a ceramic coating to not only provide a solid and smooth surface for a user to glide a mouse across, but which also has a textured finish to the surface that the optical mouse sensor can easily track to communicate the movement of the mouse to a computer with improved accuracy. Methods of manufacturing said mouse pad are also provided which are both reliable and cost-efficient.

Thus, according to a first aspect of the present invention, there is provided a mouse pad comprising a flat metal alloy sheet having a surface that has been treated with a ceramic and polymer coating to provide the surface with a desired friction co-efficient.

In some embodiments, the metal alloy is an aliminium alloy, for example, the aliminium alloy can be 6061-T6 sheet aliminium or 7075-T6 sheet aliminium.

In other embodiments, the metal alloy is a steel alloy. For example, the steel alloy may be one of the steel alloy 200, 300 and 400 series which are well known in the industry.

In some embodiments, when bonded to the metal alloy sheet, the ceramic and polymer coating produces a textured appearance on the surface of the metal alloy sheet which allows for easy recognition by an optical mouse sensor. The ceramic and polymer coating may be a cerakote coating.

According to a second aspect of the present invention, there is provided a method of manufacturing a mouse pad, the method comprising the following steps: cutting a piece of predefined dimensions from a sheet of metal alloy; applying a media blast to a first surface of the sheet, the media blast comprising the application of pressurized air to direct abrasive material at the surface; subsequent to the media blast, applying a ceramic and polymer coating to the media-blasted surface to achieve a desired friction co-efficient for the surface; and subsequent to the application of the ceramic and polymer coating, subjecting the coating to a curing process.

Apart from the order which is specifically stated these steps may be carried out in any order.

In some embodiments of the method, the curing process comprises the application of temperatures in the range of 65-150 degrees Celsius for a predefined time period.

In other embodiments of the method, the curing process comprises exposing the surface to dry air for a predefined period of time.

In some embodiments of the method, the piece of predefined dimensions is generally rectangular in shape, and the predefined dimensions are within a range of 25-51 cm in length and 25-92 cm in width.

In some embodiments of the method, the sheet of metal alloy has a thickness in the range of 0.3-0.5 cm.

According to a third aspect of the present invention, a method of manufacturing a mouse pad, the method comprising the following steps: cutting a piece of predefined dimensions from a sheet of metal alloy; submerging the sheet of metal alloy in an electrochemical bath of an anodizing fluid to encourage passivation of the metal alloy surface and form a layer of metal oxide on the surface; and subsequent to the application of the electrochemical bath, polishing or lapping one surface of the metal alloy sheet to obtain a desired smoothness.

In some embodiments, the metal alloy is one of aliminium, titanium and magnesium.

In some embodiments, the anodizing fluid is one of: Type I-Chromic Acid Anodize, Type II-Sulfuric Acid Anodize, and Type III Hard Anodize or Hardcoat from the Mil-A-8625 designation. Other less common types are phosphoric acid and titanium anodize.

### BRIEF DESCRIPTION OF THE DRAWINGS

Various embodiments of the invention are disclosed in the following detailed description and accompanying drawings.

FIG. 1 illustrates a three dimensional top down view of an example configuration of the mousepad of the present invention.

FIG. 2 illustrates a two-dimensional side view of an example configuration of the present invention to illustrate the ceramic and polymer coating having bonded to one surface of the mousepad.

### DETAILED DESCRIPTION

The following is a detailed description of exemplary embodiments to illustrate the principles of the invention. The embodiments are provided to illustrate aspects of the invention, but the invention

is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

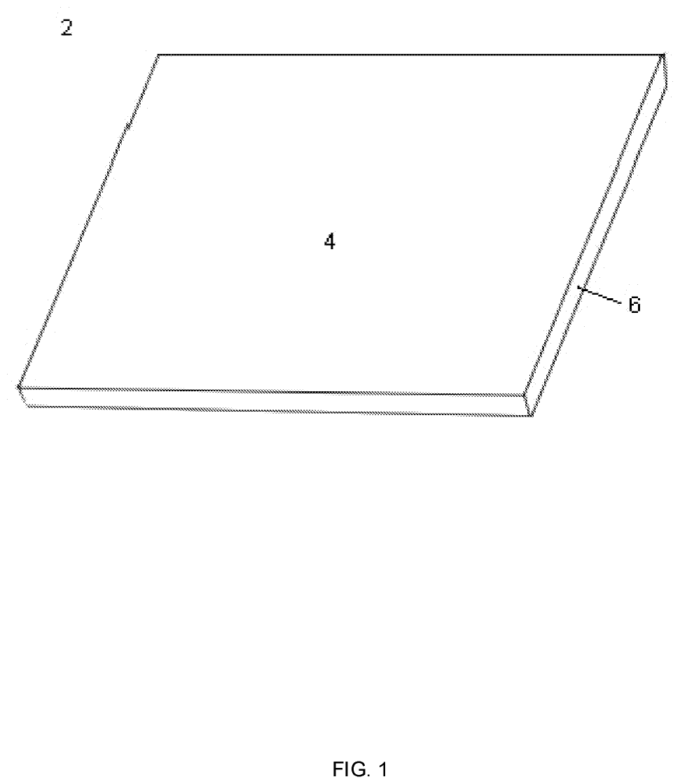

Referring to FIG. 1, a three dimensional top down view of an example configuration of the mousepad 2 of the present invention is shown.

The mousepad 2 is comprised of a metal alloy sheet 6 formed into a shape that is convenient to place on a desktop and having dimensions large enough to give a user freedom to move a mouse around on top. The metal alloy sheet provides a hard, inflexible surface one which a user can confidently put pressure without deforming the pad. The mousepad 2 has a bonded surface 4.

The metal alloy sheet 6 has two opposing flat surfaces, one untreated surface meant to rest on a surface such as a desktop and a treated surface 4 which has been cured with a ceramic polymer coating 8 such as the trademarked Cerakote coating. A person skilled in the art will recognize however that any other type of suitable ceramic polymer coating can be used to coat the top surface 4.

The top surface has a very smooth texture due to the coating which allows a user to glide the mouse over the surface 4 with great physical precision, and the coating has the further advantageous effect of providing the surface with a textured finish that the optical sensor of a modern electronic mouse will pick up, allowing the electronic tracking components to also function with the utmost accuracy.

The mousepad 2 is generally rectangular in shape and in the present example the dimensions are within a range of 25-51 cm in length and 25-92 cm in width, however it will be recognized by the skilled person that larger or smaller dimensions and different shapes could also be suitable for the mousepad 2 of the present invention.

The mousepad 2 of the present invention may be further improved by the attachment of a soft underlay with a stronger friction coefficient to the opposing, non-coated surface so that the mouse pad does not slide across a supporting surface such as a desk. This has the additional benefit that even if the surface on which the mouse pad is resting is slightly uneven the mousepad 2 itself will rest flat. This can be achieved by adding a thin adhesive rubber layer on the uncoated surface comprising for example a foam rubber base with a thin cloth woven on top. One example type of rubber that can be used for this purpose is neoprene rubber.

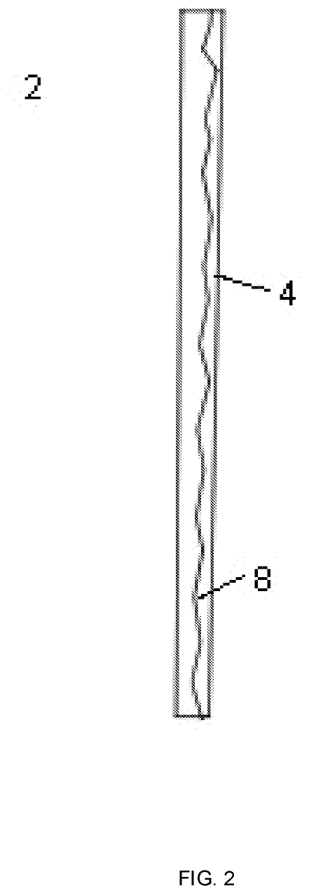

Referring to FIG. 2, a side view of an example configuration of the present invention with the ceramic and polymer coating 8 having bonded to one surface of the mousepad 2 is shown. As illustrated, in the present example the coating is applied only to one surface of the pad, and not to the other, reducing the cost of manufacture.

The process of manufacture for a mousepad 2 with the above described advantages is also provided herein.

The method involves cutting a piece of predefined dimensions from a sheet of metal alloy. This step can be performed prior to applying the coating with each mousepad 2 being coated individually, or can be done after, with a large sheet of metal alloy being bulk coated beforehand.

Prior to coating, a media blast is applied to the surface of the metal alloy sheet 6 to be coated. This involves the use of air pressure to project a stream of abrasive material at the surface, scratching the surface clean and preparing the surface particles for a clean bond to the coating material.

Subsequent to the media blast a ceramic and polymer coating 8 such as Cerakote is applied to the media-blasted surface in quantities to achieve a desired friction co-efficient for the surface.

The coating can be bonded to the surface either by exposure to air for a predefined amount of time or in a baking process where temperatures in the range of 65-150 degrees Celsius are applied to the treated surface for a predefined time period.

A second method of manufacture of a mousepad 2 having similar characteristics to the mouse pad of the present invention is also provided herein.

According to the second method, a piece of sheet metal is cut in a similar fashion to the first method, but rather than applying a ceramic polymer coating 8, the entire piece of sheet metal is anodized, with the surface to be used as a track pad then being lapped and polished once hardened to obtain an appropriate smoothness with a desirable friction coefficient.

Preferably, the anodized sheet metal is aliminium, a metal which has characteristics perfectly suited to anodization, however in some embodiments the metal can be another nonferrous metal type, such as for example titanium or magnesium.

Anodizing metal surfaces is a method known to those skilled in the art, and will therefore not be elaborated on in great detail herein. A brief summary of the process is as follows. Anodizing metal is an electrochemical passivation process by which the surface layer of a metal substrate is converted into a metal oxide layer, often accomplished by immersing the metal into an acid electrolyte bath and passing an electric current through the medium. A cathode is mounted to the inside of the anodizing tank which holds the bath; the metal acts as an anode, so that oxygen ions are released from the electrolyte to combine with the metal atoms at the surface of the part being anodized. Anodizing is, therefore, a matter of highly controlled oxidation the enhancement of a naturally occurring phenomenon.

While a natural oxide layer can be found on most metals, this layer is often uneven, thin and offers poor protection. The controlled application of an electrical charge in an acidic electrolytic bath results in a very regular and uniform layer that has increased durability, as well as wear and corrosion resistance. Additionally, these anodic layers can undergo secondary processing to incorporate various functional materials such as colorants or lubricants or, as in the case of the present invention, polishing and or lapping to achieve a desirable smoothness of surface.

The anodic oxide surface structure that results from the process is fully integrated with the underlying metal substrate, so it cannot chip or peel. It has a highly ordered, porous structure that allows for secondary processes such as colouring and sealing.

Some anodic coatings that may be suitable for use with the present invention include, but are not limited to: Type I-Chromic Acid Anodize, Type II-Sulfuric Acid Anodize, and Type III Hard Anodize or

Hardcoat from the Mil-A-8625 designation. Other less common types are phosphoric acid and titanium anodize.

As mentioned above, lapping and polishing subsequent to anodization can be very effective at smoothing the anodized surface to an appropriate finish.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications, and changes may be made without departing from the spirit of the present solution. All the features disclosed in this specification (including any accompanying claims, abstract, and drawings), and all of the steps of any method or process so disclosed, may be combined in any combination, except combinations where at least some of such features or steps are mutually exclusive.

The terms “include,” “have,” and variations thereof, as used herein, have the same meaning as the term “comprise” or an appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

1. A mouse pad comprising a flat metal alloy or glass sheet having a first surface that has been treated with a ceramic and polymer coating to provide it with a first friction coefficient and a second opposing untreated surface having attached to it an underlay having a second friction coefficient higher than the first friction coefficient.

2. A mouse pad according to claim 1, wherein the metal alloy is an aluminium alloy.

3. A mouse pad according to claim 2, wherein the aluminium alloy is 6061-T6 sheet aluminium or 7075-T6 sheet aluminium.

4. A mouse pad according to claim 1, wherein the metal alloy is a steel alloy.

5. A mouse pad according to claim 4, wherein the steel alloy is one of the steel alloy 200, 300 and 400 series.

6. A mousepad according to claim 1, wherein the ceramic and polymer coating produces a textured appearance on the surface of the metal alloy sheet which allows for easy recognition by an optical mouse sensor.

7. A mouse pad according to claim 1, wherein the ceramic and polymer coating is a cerakote coating.

8. A method of manufacturing a mouse pad, the method comprising the following steps:
a. cutting a piece of predefined dimensions from a sheet of metal alloy or glass;
b. applying a media blast to a first surface of the sheet, the media blast comprising the application of pressurised air to direct abrasive material at the surface;
c. subsequent to the media blast, applying a ceramic and polymer coating to the media-blasted surface to achieve a desired friction co-efficient for the surface;
d. subsequent to the application of the ceramic and polymer coating, subjecting the coating to a curing process.

9. A method of manufacturing a mouse pad according to claim 8, wherein the curing process comprises the application of temperatures in the range of 65-150 degrees Celsius for a predefined time period.

10. A method of manufacturing a mouse pad according to claim 8, wherein the curing process comprises exposing the surface to dry air for a predefined period of time.

11. A method of manufacturing a mouse pad according to claim 8, wherein the piece of predefined dimensions is generally rectangular in shape, and the predefined dimensions are within a range of 25-51 cm in length and 25-92 cm in width.

12. A method of manufacturing a mouse pad according to claim 8, wherein the sheet of metal alloy has a thickness in the range of 0.3-0.5 cm.

13. A method of manufacture according to claim 8, wherein the metal alloy is one of aluminium, titanium, steel, and magnesium.

14. A method of manufacturing a mouse pad, the method comprising the following steps:
a. cutting a piece of predefined dimensions from a sheet of metal alloy;
b. submerging the sheet of metal alloy in an electrochemical bath of an anodizing fluid to encourage passivation of the metal alloy surface and form a layer of metal oxide on the surface; and
c. subsequent to the application of the electrochemical bath, polishing or lapping one surface of the metal alloy sheet to obtain a desired smoothness.

15. A method of manufacture according to claim 14, wherein the metal alloy is one of aluminium, titanium, steel, and magnesium.

16. A method of manufacture according to claim 14, wherein the anodizing fluid is one of: Type I-Chromic Acid Anodize, Type H-Sulfuric Acid Anodize, and Type III Hard Anodize or Hardcoat from the Mil-A-8625 designation. Other less common types are phosphoric acid and titanium anodize.
